(19) United States
(12) Patent Application Publication
(10) Pub. No.: US 2016/0032059 A1
(43) Pub. Date: Feb. 4, 2016

(54) RADIATION CURABLE POLYTHIOETHERS WITH ALKYNE-BASED LINKAGE

(71) Applicant: 3M INNOVATIVE PROPERTIES COMPANY, Saint Paul, MN (US)

(72) Inventors: Sheng Ye, Woodbury, MN (US); Robin E. Wright, Hudson, WI (US); Jonathan D. Zook, Baytown Township, MN (US); Susan E. DeMoss, Stillwater, MN (US)

(73) Assignee: 3M INNOVATIVE PROPERTIES COMPANY, Saint Paul, MN (US)

(21) Appl. No.: 14/775,018

(22) PCT Filed: Mar. 5, 2014
(86) PCT No.: PCT/US14/20587

§ 371 Date: Sep. 11, 2015

Related U.S. Application Data
(60) Provisional application No. 61/779,485, filed on Mar. 13, 2013.

(51) Int. Cl. C08G 75/14

(52) U.S. Cl. CPC C08G 75/14

(57) ABSTRACT

Certain polythioether polymers are presented, as well as compositions which are radiation curable to polythioether polymers and seals and sealants comprising same. The compositions radiation curable to polythioether polymers include those comprising: a) at least one dithiol monomer; b) at least one diene monomer; c) at least one polyyne monomer comprising at least two ethyne groups; and d) at least one photoinitiator. In some embodiments, the polyyne monomer is a diyne monomer. In some embodiments, the composition also comprises at least one epoxy resin. In another aspect, the compositions radiation curable to polythioether polymers include those comprising: f) at least one thiol terminated polythioether polymer; g) at least one diyne monomer; and h) at least one photoinitiator. In some embodiments the thiol terminated polythioether polymer comprises pendent hydroxide groups.

### CROSS REFERENCE TO RELATED APPLICATIONS

This application claims priority from U.S. Provisional Application Ser. No. 61/779485, filed 13 Mar. 2013, the disclosure of which is incorporated by reference in its/their entirety herein.

### FIELD OF THE DISCLOSURE

This disclosure relates to certain polythioether polymers, compositions which are radiation curable to polythioether polymers, and seals and sealants comprising same.

### SUMMARY OF THE DISCLOSURE

Briefly, the present disclosure provides a composition which is radiation curable to a polythioether polymer, comprising: a) at least one dithiol monomer; b) at least one diene monomer; c) at least one polyyne monomer comprising at least two ethyne groups; and d) at least one photoinitiator. In some embodiments the composition may additionally comprise e) at least one epoxy resin.

In another aspect, the present disclosure provides a composition which is radiation curable to a polythioether polymer, comprising: a) at least one dithiol monomer; b) at least one diene monomer; c) at least one diyne monomer; and d) at least one photoinitiator. In some embodiments the composition may additionally comprise e) at least one epoxy resin.

In another aspect, the present disclosure provides a composition which is radiation curable to a polythioether polymer, comprising: f) at least one thiol terminated polythioether polymer; g) at least one diyne monomer; and h) at least one photoinitiator. In some embodiments the thiol terminated polythioether polymer comprises pendent hydroxide groups.

In some embodiments, the compositions described herein may additionally comprise a filler, in some embodiments a nanoparticle filler. In some embodiments, the composition may additionally comprise calcium carbonate. In some embodiments, the composition may additionally comprise nanoparticle calcium carbonate.

In some embodiments, the compositions described herein visibly change color upon cure. In some embodiments, the compositions described herein are curable by an actinic light source. In some embodiments, the compositions described herein are curable by a blue light source. In some embodiments, the compositions described herein are curable by a UV light source.

In another aspect, the present disclosure provides a sealant comprising any of the compositions described herein. In some embodiments, the sealant is transparent. In some embodiments, the sealant is translucent.

In another aspect, the present disclosure provides a polythioether polymer obtained by radiation cure of any the radiation curable compositions described herein. In some embodiments, the polythioether polymer has a Tg less than −55° C. In some embodiments, the polythioether polymer exhibits high jet fuel resistance characterized by a volume swell of less than 30% and a weight gain of less than 20% when measured according to Society of Automotive Engineers (SAE) International Standard AS5127/1.

In another aspect, the present disclosure provides a seal comprising any of the polythioether polymers described herein. In some embodiments, the seal is transparent. In some embodiments, the seal is translucent.

### DETAILED DESCRIPTION

The present disclosure provides radiation curable polythioether polymers including alkyne linkages which may be particularly useful as sealant materials due to characteristics such as low Tg and high resistance to solvents such as jet fuel.

In some embodiments, the present disclosure relates to mercaptan based polythioether sealants containing radical photoinitiators. In some embodiments, the present disclosure relates to sealants that may be cured on demand in a one-step process in seconds by UV/LED radiation sources. In some embodiments, the sealants include fillers. In some embodiments, the sealants exclude fillers. In some embodiments, the sealant formulation contains a mercaptan based monomer (such as a dithiol) or oligomer (such as a linear polythioether or polysulfide), a diene or divinylether, a diyne, and a radical photoinitiator (such as Irgacure 819). In some embodiments, the sealant formulation includes an epoxy resin. In some embodiments, the sealant formulation includes calcium carbonate or nanoparticle calcium carbonate. By exposure to light around 450 nm, these compounds are curable in seconds to a rubber with low glass transition temperature (around −60 ° C.) and fuel resistance properties. As a result, use of the present sealant formulations has the potential to accelerate manufacturing.

In some embodiments, the sealant according to the present disclosure can simultaneously provide a long application life and cured on demand. In some embodiments, the sealant according to the present disclosure exhibit favorable solvent and fuel resistance properties. In some embodiments, the sealant according to the present disclosure exhibit favorable thermal resistance properties.

In some embodiments, the user applies the sealant according to the present disclosure as a single-component liquid formulation to the structure requiring sealing. In some embodiments, the user applies the sealant according to the present disclosure as a multi-component liquid formulation to the structure requiring sealing. In some embodiments, the sealant remains liquid and usable until the user applies an external source of electromagnetic (EM) radiation. Any suitable source of EM radiation can be used, most typically selected from actinic, blue and/or UV radiation. Upon application of the external EM radiation the liquid sealant then cures or crosslinks. In some embodiments, the sealant cures or crosslinks to an at least partially elastomeric solid in less than one minute.

This disclosure is useful in sealants, and in particular for the aerospace industry.

Objects and advantages of this disclosure are further illustrated by the following examples, but the particular materials and amounts thereof recited in these examples, as well as other conditions and details, should not be construed to unduly limit this disclosure.

### EXAMPLES

Unless otherwise noted, all reagents were obtained or are available from Sigma-Aldrich Company, St. Louis, Mo., or may be synthesized by known methods. Unless otherwise reported, all ratios are by weight percent.

The following abbreviations are used to describe the examples:

° C.: degrees Centigrade

cm: centimeter

LED: light emitting diode

mm: millimeter

nm: nanometer

T_{g}: glass transition temperature

W: Watt

### Materials.

Abbreviations for the reagents used in the examples are as follows:
DMDO: 1,8-Dimercapto-3,6-dioxaoctane, obtained from Arkena, Inc., King of Prussia, Pa.
DVE-2: Diethyleneglycol divinyl ether, obtained from BASF Corp., Florham Park, N.J.
DVE-3: Triethyleneglycol divinylether, obtained under the trade designation “RAPI-CURE DVE-3” from Ashland Specialty Ingredients, Wilmington, Del.
E-8220: A diglycidylether of bisphenol F, obtained under the trade designation “EPALLOY 8220” from Emerald Performance Materials, LLC, Cuyahoga Falls, Ohio.
HDY: 1,6-heptadiyne, obtained from GFS Chemicals, Inc., Powell, Ohio.
I-819: Phenylbis(2,4,6-trimethylbenzoyl)phosphine Oxide, obtained under the trade designation “IRGACURE 819” from BASF Corp., Florham Park, N.J..
NCC: Nanoparticle (70-100 nm) calcium carbonate, obtained under the trade designation “SOCAL 31” from Solvay Chemicals, Inc., Houston, Tex.
ODY: 1,7-octadiyne, obtained from ChemSampCo, Inc., Trenton, N.J.
PTE: A liquid polythioether polymer prepared as follows. Into a 5 liter round bottom flask equipped with an air driven stirrer, thermometer, and a condenser, was added 167.1 grams (0.51 mol) E-8220 and 1641 grams (9.0 mol) DMDO. After several minutes of stirring the mixture exothermed to 45° C. After another 30 minutes, the temperature of the flask was increased 75° C. and a mixture of 1428.1 grams (7.1 mol) DVE-3, 50.7 grams (0.2 mol) TAC and 13.1 grams (0.07 mol) VAZO-67 was added drop wise. The reaction proceeded substantially to completion affording 3,300 grams of polythioether polymer.
TAC: Triallylcyanurate, obtained from Sartomer, Inc., Exton, Pa.
VAZO-67: 2,2′-azobis(2-methylbutyronitrile, obtained under the trade designation “VAZO-67” from E.I. du Dupont de Nemours and Company, Wilmington, Del.

### Example 1

A curable polythioether composition was prepared as follows. A 40 ml. amber glass vial was charged with 7.000 grams DMDO, 5.212 grams DVE-2, 0.125 grams 1-819 and 0.251 grams HDY at 21° C. The vial was then sealed and placed on a laboratory roller mill for 10 minutes until the I-819 had dissolved.

### Example 2

A curable polythioether composition was prepared as generally described in Example 1, wherein after the resin and initiator were dissolved, 1.888 grams NCC was homogeneously dispersed in the composition by means of a high speed mixer for 1 minute.

### Example 3

A curable polythioether composition was prepared as generally described in Example 1, wherein the HDY was substituted with 0.289 grams ODY.

### Example 4

A curable polythioether composition was prepared as generally described in Example 3, wherein after the resin and initiator were dissolved, 1.894 grams NCC was homogeneously dispersed in the composition by means of a high speed mixer for 1 minute.

### Example 5

A 40 ml. amber glass vial was charged with 10.000 grams PTE, 0.102 grams 1-819 and 0.172 grams HDY at 21° C. The vial was then sealed and placed on a laboratory roller mill for 12 hours until the 1-819 had dissolved.

### Example 6

A curable polythioether composition was prepared as generally described in Example 5, wherein after the resin and initiator were dissolved, 1.545 grams NCC was homogeneously dispersed in the composition by means of a high speed mixer for 1 minute.

### Example 7

A curable polythioether composition was prepared as generally described in Example 5, wherein the HDY was substituted with 0.198 grams ODY.

### Example 8

A curable polythioether composition was prepared as generally described in Example 7, wherein after the resin and initiator were dissolved, 1.545 grams NCC was homogeneously dispersed in the composition by means of a high speed mixer for 1 minute.

### Example 9

A curable polythioether composition was prepared as generally described in Example 3, wherein the amount of 1-819 was increased to 0.250 grams.

### Example 10

A curable polythioether composition was prepared as generally described in Example 9, wherein after the resin and initiator were dissolved, 1.913 grams NCC was homogeneously dispersed in the composition by means of a high speed mixer for 1 minute.
Samples were poured into a nominally 2 cm by 2 cm silicone rubber mold of various heights, at 21° C. and cured by exposure, according to the times listed in Table 1, to one of the following actinic light sources:

A 4 W/cm², 395 nm LED, model “STARFIRE MAX” from Phoseon Technology, Hillsboro, Oregon, at a distance of 2.54 cm, or

A 455 nm LED, model “CF2000”, obtained from Clearstone Technologies, Inc., Minneapolis, Minn., at a distance of 0.635 cm.

### Test Methods.

The following test methods were used to evaluate cured samples:
Shore A Hardness: Measured using a model “1600” hardness gauge, obtained from Rex Gauge Company, Inc., Buffalo Grove, Ill.
T_{g}: Measured using a model “DSC Q2000” differential scanning calorimeter, obtained from TA Instruments, New Castle, Del.
Jet Fuel Resistance: Measured according to Society of Automotive Engineers (SAE) International Standard AS5127/1, wherein samples were immersed in Jet Reference Fluid Type 1 (JRF1) for 7 days at 60° C., after which % swell and % weight gain of the sample were determined JRF1 composition is defined by SAE Standard AMS2629.
Color Change: Measured before and after curing using a model “MINISCAN XE PLUS D/8S” colorimeter, in mode D65/10*, obtained from Hunter Associates Laboratory, Inc., Reston, Va.

Results listed in Table 1 represent the average values of triplicate samples measured for thickness and Shore A hardness, and the average values for duplicate measurements of T_{g}. Selected examples were also subjected to the Jet Fuel Resistance test, and are reported in Table 2.

Color change measurements, as an average of three reading and expressed as L*a*b* and ΔE values, are listed in Table 3.

TABLE 1

| | | | | Shore A | |
|---|---|---|---|---|---|
| | | Cure Time | Thickness | Hardness | T_{g} |
| Example | Light Source | (Seconds) | (mm) | (%) | (° C.) |
| 1 | STARFIRE MAX | ≧180 | Insufficiently Cured - | | |
| | | | Not Measured | | |
| 2 | STARFIRE MAX | 60 | 2.1 | 35.6 | −63.0 |
| 3 | STARFIRE MAX | ≧180 | Insufficiently Cured - | | |
| | | | Not Measured | | |
| 3 | CF2000 | 30 | 11.1 | 42.0 | −60.8 |
| 4 | STARFIRE MAX | 10 | 2.2 | 54.0 | −62.7 |
| 4 | CF2000 | 30 | 4.3 | 60.0 | −61.9 |
| 5 | STARFIRE MAX | ≧180 | Insufficiently Cured - | | |
| | | | Not Measured | | |
| 6 | STARFIRE MAX | 180 | 2.3 | 48.6 | −59.7 |
| 7 | STARFIRE MAX | 180 | 2.5 | 41.4 | −60.1 |
| 7 | CF2000 | 30 | 3.4 | 43.0 | −58.6 |
| 8 | STARFIRE MAX | 15 | 2.0 | 59.8 | −59.7 |
| 8 | CF2000 | 30 | 4.4 | 46.0 | −59.6 |

TABLE 2

| | Jet Fuel Resistance Test | | |
|---|---|---|---|
| | | | % Weight Loss |
| Example | % Volume Swell | % Weight Gain | Upon Drying |
| 2 | 21 | 13 | 3.8 |
| 4 | 22 | 14 | 3.2 |
| 8 | 25 | 17 | 3.6 |

TABLE 3

| Example | Curing Step | L* | a* | b* | ΔE |
|---|---|---|---|---|---|
| 9 | Before | 88.35 | −11.44 | 25.57 | 16.79 |
| | After | 86.82 | −4.39 | 10.41 | |
| 10 | Before | 84.82 | −11.81 | 19.80 | 14.37 |
| | After | 83.80 | −4.76 | 7.32 | |

Various modifications and alterations of this disclosure will become apparent to those skilled in the art without departing from the scope and principles of this disclosure, and it should be understood that this disclosure is not to be unduly limited to the illustrative embodiments set forth hereinabove.

1. A composition which is radiation curable to a polythioether polymer, comprising:
a) at least one dithiol monomer;
b) at least one diene monomer;
c) at least one polyyne monomer comprising at least two ethyne groups; and
d) at least one photoinitiator.

2. A composition which is radiation curable to a polythioether polymer, comprising:
a) at least one dithiol monomer;
b) at least one diene monomer;
c) at least one diyne monomer; and
d) at least one photoinitiator.

3. The composition according to claim 1 additionally comprising:
e) at least one epoxy resin.

4. A composition which is radiation curable to a polythioether polymer, comprising:
f) at least one thiol terminated polythioether polymer;
g) at least one diyne monomer; and
h) at least one photoinitiator.

5. The composition according to claim 4 wherein the at least one thiol terminated polythioether polymer comprises pendent hydroxide groups.

6. The composition according to claim 1 additionally comprising:
i) at least one filler.

7. The composition according to claim 1 additionally comprising:
j) at least one nanoparticulate filler.

8. The composition according to claim 1 additionally comprising:
k) calcium carbonate.

9. The composition according to claim 1 additionally comprising:
l) nanoparticle calcium carbonate.

10. The composition according to claim 1 which visibly changes color upon cure.

11. The composition according to claim 1 which is curable by actinic light source.

12. The composition according to claim 1 which is curable by blue light source.

13. The composition according to claim 1 which is curable by UV light source.

14. A sealant comprising the composition according to claim 1.

15. A branched polythioether polymer obtained by radiation cure of any the composition according to claim 1.

16. The branched polythioether polymer according to claim 15 having a Tg less than −55° C.

17. The branched polythioether polymer according to claim 15 which exhibits high jet fuel resistance characterized by a volume swell of less than 30% and a weight gain of less than 20% when measured according to Society of Automotive Engineers (SAE) International Standard AS5127/1.

18. A seal comprising the branched polythioether polymer according to claim 1.

19. The sealant according to claim 14 which is transparent.

20. The sealant according to claim 14 which is translucent.

21. The seal according to claim 18 which is transparent.

22. The seal according to claim 18 which is translucent.

23. The composition according to claim 2 additionally comprising:
e) at least one epoxy resin.

24. The composition according to claim 2 additionally comprising:
i) at least one filler.

25. The composition according to claim 2 additionally comprising:
j) at least one nanoparticulate filler.

26. The composition according to claim 2 additionally comprising:
k) calcium carbonate.

27. The composition according to claim 2 additionally comprising:
l) nanoparticle calcium carbonate.

28. The composition according to claim 2 which visibly changes color upon cure.

29. A sealant comprising the composition according to claim 2.

30. A branched polythioether polymer obtained by radiation cure of the composition according to claim 2.

31. The branched polythioether polymer according to claim 30 having a Tg less than −55° C.

32. The branched polythioether polymer according to claim 30 which exhibits high jet fuel resistance characterized by a volume swell of less than 30% and a weight gain of less than 20% when measured according to Society of Automotive Engineers (SAE) International Standard AS5127/1.

33. The composition according to claim 4 additionally comprising:
i) at least one filler.

34. The composition according to claim 5 additionally comprising:
i) at least one filler.

35. The composition according to claim 4 additionally comprising:
j) at least one nanoparticulate filler.

36. The composition according to claim 5 additionally comprising:
j) at least one nanoparticulate filler.

37. The composition according to claim 4 additionally comprising:
k) calcium carbonate.

38. The composition according to claim 5 additionally comprising:
k) calcium carbonate.

39. The composition according to claim 4 additionally comprising:
l) nanoparticle calcium carbonate.

40. The composition according to claim 5 additionally comprising:
l) nanoparticle calcium carbonate.

41. The composition according to claim 4 which visibly changes color upon cure.

42. The composition according to claim 5 which visibly changes color upon cure.

43. A branched polythioether polymer obtained by radiation cure of the composition according to claim 4.

44. A branched polythioether polymer obtained by radiation cure of the composition according to claim 5.

45. The branched polythioether polymer according to claim 43 having a Tg less than −55° C.

46. The branched polythioether polymer according to claim 44 having a Tg less than −55° C.
